(19) United States
(12) Patent Application Publication
(10) Pub. No.: US 2004/0148313 A1
(43) Pub. Date: Jul. 29, 2004

(54) System and method for generating educational content structure

(76) Inventors: Jim Jin Lu, Dundas (CA); Artem Grinchenko, Toronto (CA)

Correspondence Address: T Andrew Currier, Lang Michener, Suite 2500, BCE Place, 181 Bay Street, Toronto, M5J 2T7, CA

(21) Appl. No.: 10/352,137

(22) Filed: Jan. 28, 2003

(51) Int. Cl. G06F 17/00; G06F 7/00

(52) U.S. Cl. 707/104.1

(57) ABSTRACT

A method and system is provided for generating educational content in an enterprise learning environment that allows for the reuse of learning objects. In an embodiment, the system includes an educational content generation engine that has access to a SCORM v 1.2 content aggregation and a skill requirements database that match the content structure of the content aggregation. The generation engine is operable to detect changes in either the content aggregation or the skill requirements database, and made changes to either or both of the content aggregation and the skill requirements database to bring them into synchronization, thereby allowing ready reuse of learning objects, without the need for manually regenerating the content aggregation when new learning objects or content structures are introduced.

### FIELD OF THE INVENTION

The present invention relates to generally to electronic or enterprise learning and more particularly relates to a system and method for generating an educational content structure in the context of enterprise learning.

### BACKGROUND OF THE INVENTION

The concept of a learning object is well known in the enterprise learning industry. Various bodies have worked to create or contribute to standards for learning objects. For example, the IEEE Learning Technology Standards Committee (LTSC) has developed a document entitled “Draft Standard for Learning Object Metadata” dated Jul. 15, 2002 (“LTSC Draft Standard”). The LTSC Draft Standard defines, a learning object as “as any entity -digital or non-digital- that may be used for learning, education or training.” Other important work in the development of learning objects has been conducted by the Aviation Industry CBT (Computer-Based Training) Committee (“AICC”). Still further work has been conducted by Advanced Distributed Learning Initiative (“ADL”), which has promulgated the Sharable Content Object Reference Model™ (“SCORM”). In the words of the ADL, “SCORM defines a Web-based learming “Content Aggregation Model” and “Run-Time Environment” for learning objects. . . . The SCORM applies current technology developments to a specific content model by producing recommendations for consistent implementations by the vendor community. It is built upon the work of the AICC, IMS, IEEE, ARIADNE and others to create one unified “reference model” of interrelated technical specifications and guidelines designed to meet DoD's high-level requirements for Web-based learning content.” (http://www.adlnet.org)

One goal of a learning object standard such as SCORM is to provide a means to efficiently and elegantly reuse learning content in different learning environments. However, one problem with SCORM is that the resulting learning environment package created from SCORM includes a substantially fixed content structure that points to each of the learning objects. Thus, while the learning objects themselves are ultimately reusable, the content structure that provides the pathway for how those learning objects will be used is fixed. As a result, when it is desired to reuse the learning object in a different learning environment, it is typically necessary for the content structure to be manually regenerated—much in the same way other prior art learning environments manually regenerate content structures as learning environment needs change. For example, in the learning environment of university course, the content structure (i.e. course structure) is manually created, and manually updated, to suit the current needs of the learning environment. As a result, SCORM can confine otherwise flexible learning objects within a relatively fixed, manually generated content structure, thereby interfering with the overall goal of providing easily reusable content.

### SUMMARY OF THE INVENTION

In a first aspect of the invention there is provided a system for generating educational content comprising a first database for storing at least one learning object, a second database for storing at least one content structure that points to the at least one learning object and a third database for storing at least one set of skill requirements. The system also includes a content generator engine operable to receive the databases and perform a synchronization operation and output an additional one or more databases including a synchronized version of the first second and third databases.

In a particular implementation of the first aspect, the system further comprising a content delivery engine for delivering the educational content to a user.

In a particular implementation of the first aspect, the system the synchronization operation includes comparing the at least one content structure with the at least one skill requirements and updating a desired one of the content structure and the skill requirements based on detected differences therebetween and the outputted additional database comprises the update.

In a second aspect of the invention, there is provided a method of generating educational content comprising the steps of:

receiving a first set of data representing at least one skill requirement;

receiving a second set of data representing a content structure; receiving a third set of data representing at least one sharable content object referenced by the content structure;

synchronizing the skill requirements with the content structure; and

outputting data representing the synchronizing step.

In a particular implementation of the second aspect, when the third database and the second database are synchronized and the second database is not synchronized with the first database, then the synchronization step includes the generation of a fourth database based on the second database such that the fourth database is synchronized with the first database, and the synchronization step further generates a fifth database based on the third database such that the fifth database is synchronized with the fourth database.

In a particular implementation of the second aspect, the first database was changed out of synchronization with the second database by extracting one or more learning objects from a SCORM compliant manifest file generated by a third-party and incorporating those extracted learning objects into the first database.

In a particular implementation of the second aspect, when the first database and the second database are synchronized and the third database is not synchronized with the second database, then the synchronization step includes the generation of a fourth database based on the third database such that the fourth database is synchronized with the second database.

In a particular implementation of the second aspect, the third database was changed out of synchronization with the second database by content delivery engine receiving a dossier of existing student skills reflecting that the existing student's skills overlapped with at least one preexisting the skill requirement in the third database, and the third database was changed to delete the requirement for the at least one preexisting skills.

In a third aspect of the invention, there is provided a method of generating a set of skill requirements comprising the steps of:

receiving data representing existing requirements;

receiving data representing a student's existing skills; determining overlaps between the existing skills and the existing requirements; and,

generating a new set of skill requirements that omits any determined overlaps.

### BRIEF DESCRIPTION OF THE DRAWINGS

The present invention will now be explained, by way of example only, with reference to certain embodiments and the attached Figures in which:

FIG. 1 is a diagram of an aggregation of learning objects and content structure according to the prior art;

FIG. 2 is a schematic representation of a system for generating and delivering educational content in accordance with an embodiment of the invention;

FIG. 3 is a schematic representation of an exemplary skill requirements database stored in the system of FIG. 2;

FIG. 4 is a schematic representation of a skill set from the skills requirements database of FIG. 3 beside a content structure that is part of the content structure database shown in FIG. 2;

FIG. 5 is a schematic representation of an exemplary SCORM v1.2 compliant content aggregation consisting of the content structure shown in FIG. 4 and a pool of learning objects stored on the learning objects database of FIG. 2;

FIG. 6 is a flowchart depicting a method for generating educational content in accordance with another embodiment of the invention;

FIG. 7 is a schematic representation of an exemplary content aggregation generated using the method of FIG. 6;

FIG. 8 is a flowchart depicting a set of sub-steps for one of the steps in the method of FIG. 6 in accordance with another embodiment of the invention;

FIG. 9 is a schematic representation of a skill set generated from the content structure in FIG. 7 generated using the method in FIG. 8;

FIG. 10 is a schematic representation of an another exemplary skill requirements database stored in the system of FIG. 2;

FIG. 11 is a schematic representation of a content structure generated from the skill set from the skill requirements database of FIG. 10;

FIG. 12 is a schematic representation of a content aggregation generated from the content structure of FIG. 11;

FIG. 13 is flowchart depicting a method of generating a skill requirements database from a dossier of existing student skills in accordance with another embodiment of the invention;

FIG. 14 shows a side-by-side comparison of exemplary data received in the method shown in FIG. 14;

FIG. 15 shows a generation of a skill set for a skill requirements database using the method shown in FIG. 13;

FIG. 16 is a schematic representation of a content structure generated from the skill set from the skill requirements database of FIG. 15; and,

FIG. 17 is a schematic representation of a content aggregation generated from the content structure of FIG. 16.

### DESCRIPTION OF THE INVENTION

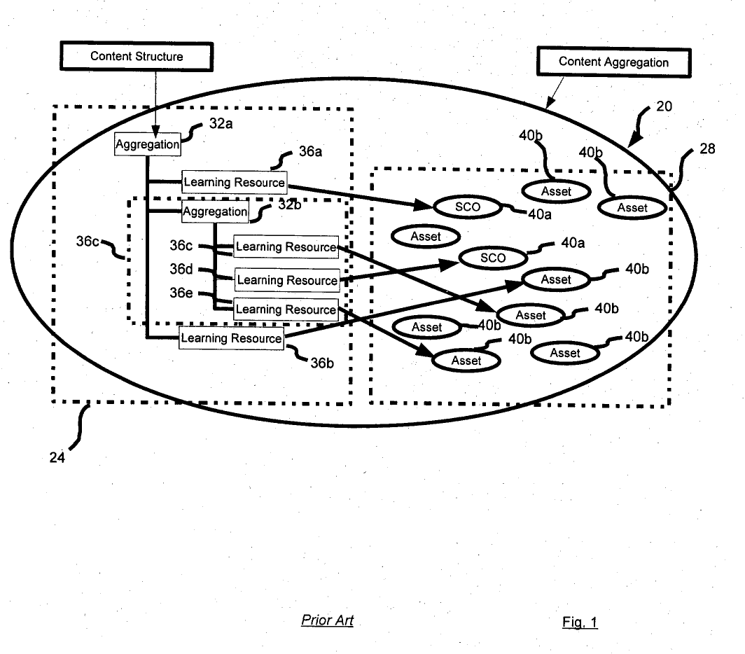

Before describing embodiments of the present invention in detail, a prior art content structure will be described. Referring now to FIG. 1, a prior art content aggregation is indicated generally at 20. Content aggregation 20 complies with the SCORM Version 1.2 and comprises a content structure 24 and a learning content pool 28. Content structure 24 is represented by a tree having a root 32a representing the identity of structure 24, and whose leaves 36a, 36b point to learning objects 40 within pool 28. Leaf 36c of structure 24 is itself a content sub-structure that has its own sub-leaves 36c, 36d and 36e that identify their own learning objects 40 within pool 28.

Learning content pool 28 thus comprises a plurality of learning objects 40. Learning objects 40 include assets 40a, which are learning content in its most basic form, and are typically electronic representations of media, text, images, sound, web pages, chat sessions, assessment objects or other pieces of data that can be delivered electronically such as via a Web client device. Learning objects 40 also include a plurality of SCOs 40b, (where SCO means Sharable Content Object, according to the SCORM Verison 1.2). SCOs 40b represent a collection of assets 40a and/or other types of sharable learning resources that include a specific launchable asset that utilizes the SCORM Run-time enviromnent to communicate with Learning Management System (“LMSs”). One SCO 40b represents the lowest level of granularity of content that is able to be tracked by an LMS using the SCORM Run-time Environment.

Having thus defined a particular content aggregation 20, it is implemented in software as a compound file, (which may or may not contain meta-data about its components), often referred to as a manifest file. In turn, this manifest file can be run on appropriate hardware to access to the hardware storage resources that maintain learning resource pool 28, and thereby deliver the learning objects 40 that correspond to a specific leaf 36 in content structure 32a to a user that wishes to access learning objects 40 as part of an educational exercise.

However, a problem with the foregoing is that, should the requirements of the educational exercise change, then content structure 24 itself must be changed. In at least some prior art environments, this requires a manual analysis of the particular content being delivered by a given set of learning objects 40, manually rebuilding a new structure 24 and then generating a new associated manifest file for deployment on the hardware resources. Accordingly, while the learning objects 40 are individually reusable, their fixed relationship to structure 24 can reduce the overall ease with which they can be reused. The course structure, in it's turn, by virtue of having fixed relationship with its learning objects is static and meant to be delivered in its entirety, thus limiting dynamic publishing tailored for specific needs of a student.

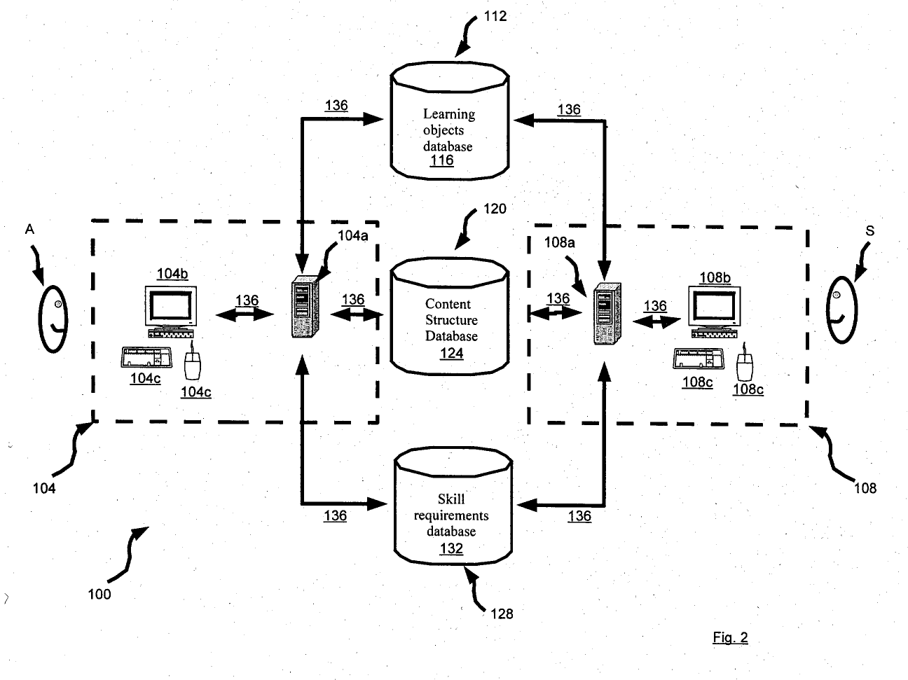

Referring now to FIG. 2, a system for generating and delivering educational content in accordance with an embodiment of the invention is indicated generally at 100. System 100 includes a content generation engine 104 comprised of a CPU tower 104a and at least one user output device 104b and at least one user input device 104c. System 100 also includes a content delivery engine 108 that also comprises a CPU tower 108a and at least one user output device 108b and at least one user input device 108c. In the present embodiment, user output devices 104b and 108b are monitors, while user input devices 104c and 108c include a mouse and a keyboard. System 100 also includes a learning objects storage device 112, which houses a learning objects database 116 and a content structure storage device 120 which houses a content structure database 124. System 100 also includes a skill requirements storage device 128, which houses a skill requirements database 132. The various components in system 100 are operable to communicate with each other via a plurality of interconnections 136 as shown in FIG. 2.

While not shown in FIG. 2 (and not required), it is also contemplated that the various components in system 100 are all connected to a wide area network, such as the Internet, and that the following discussion regarding system 100 can involve interactions with the Internet to effect the operation, functionality and features described herein.

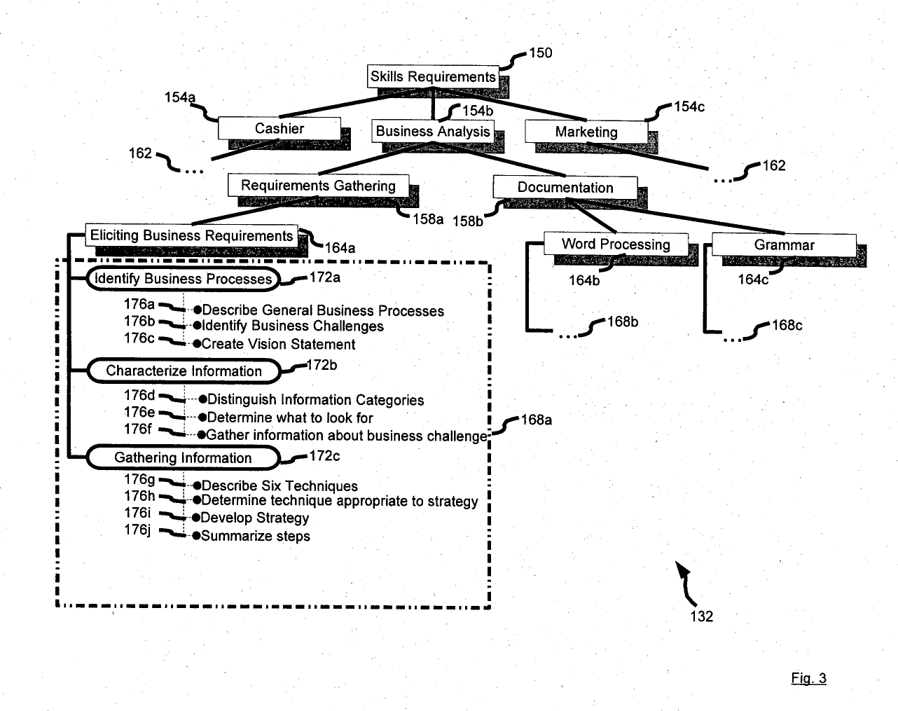

FIG. 3 shows a schematic representation of an exemplary skill requirements database 132, as stored on storage device 128. Skill requirements database 132 is represented as a tree structure, having a root 150 that identifies database 132 as containing skill requirements. According to the example in FIG. 3, database 132 represents a complete set of skill requirements for all positions within a retail department store. The first three leaves 154a, 154b and 154c (which may also be referred to as “branches”) depending from root 150 reflect three different divisions within the retail department store having particular skill requirements for personnel working in those areas. Thus, leaf 154a identifies “Cashier”, leaf 154b identifies “Business Analysis” and leaf 154c identifies “Marketing” as different divisions within the department store. While it is contemplated that all three leaves 154a, 154b and 154c all have their own child leaves depending from each, FIG. 3 only shows further leaves 158 depending from leaf 154b “Business Analysis”, while ellipsis (i.e. three dots in a row, or “ . . . ”), identified at 162, are shown beneath leaves 154a and 154c to depict that other leaves are depending from each of leaf 154a and leaf 154c.

The foregoing structure is then repeated again, with leaf 158a “Requirements Gathering”, having leaf 164a “Eliciting Business Requirements” depend therefrom, and with leaf 158b “Documentation” having leaf 164b “Word Processing” and leaf 164 “Grammar” depend therefrom.

The above-described leaves 154, 158, and 164 are shown as shadowed-rectangles, to depict that these leaves represent skill groups and skill sub-groups. However, beneath the skill sub-groups represented by leaves 164a, 164b and 164c is a respective skill set 168a, 168b and 168c. Skill set 168a, in turn, comprises a number of complex skills 172 that group a number simple skills 176. (Skill sets 168b and 168c are shown in ellipsis, to indicate that they to have their own complex skills and simple skills, but which are not explicitly shown in FIG. 3.)

In the example shown in FIG. 3, complex skills 172 comprise a first complex skill 172a “Identify Business Processes”, a second complex skill 172b “Characterize Information” and a third complex skill 172c “Gathering Information”. Complex skill 172a “Identify Business Processes” includes simple skill 176a “Describe General Business Processes”, simple skill 176b “Identify Business Challenges”, and simple skill 176c “Create Vision Statement”.

Complex skill 172c “Characterize information” includes simple skills 176d “Distinguish Information Categories”, simple skill 176e “Determine what to look for”, and simple skill 176f “Gather information about business challenge”.

Complex skill 172d “Gathering information” includes simple skill 176g “Describe Six Techniques”, simple skill 176h “Determine techniques appropriate to strategy”, simple skill 176i “Develop Strategy” and simple skill 176j “Summarize steps”.

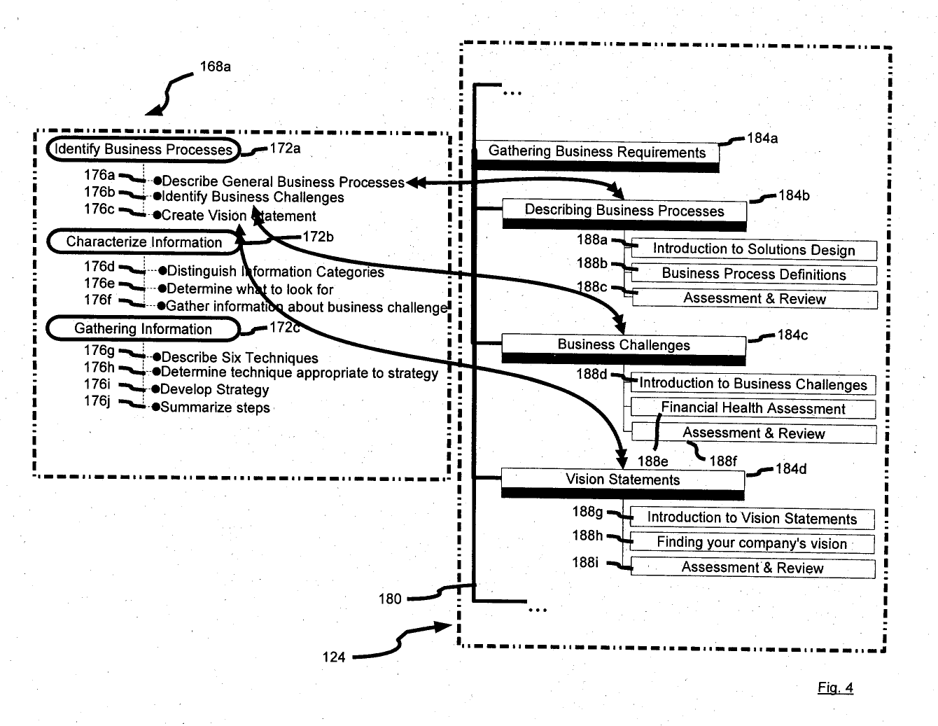

FIG. 4 shows skill set 168a from skills requirements database 132 beside a content structure 180 that is part of content structure database 124. Content structure 180 corresponds with skill set 168a, and the mappings between complex skills 176a, 176b and 176c and their corresponding portions in content structure 180 are shown with double-arrow head lines. (The mappings between complex skills 176c-176f and manifest 180 are not explicitly identified).

Content structure 180 is incorporated into a SCORM v 1.2 IMS Manifest XML file and is of substantially the same format as the content structure 24 shown in FIG. 1 used to describe the prior art. Thus, the content structure 180 in FIG. 4 is represented by a tree having a first root 184a “Gathering Business Requirements” representing the identity of file 180, that points to sub-root 184b “Describing Business Processes”, sub-root 184c “Business Challenges” and sub-root 184d “Vision Statements”. In turn, sub-root 184b “Describing Business Processes” has learning object pointer leaves 188a, 188b, and 188c. Sub-root 184c “Business Challenges” has learning object pointer leaves 188c, 188d and 188e. Sub-root 184d “Vision Statements” has learning object pointer leaves 188f, 188g, and 188h.

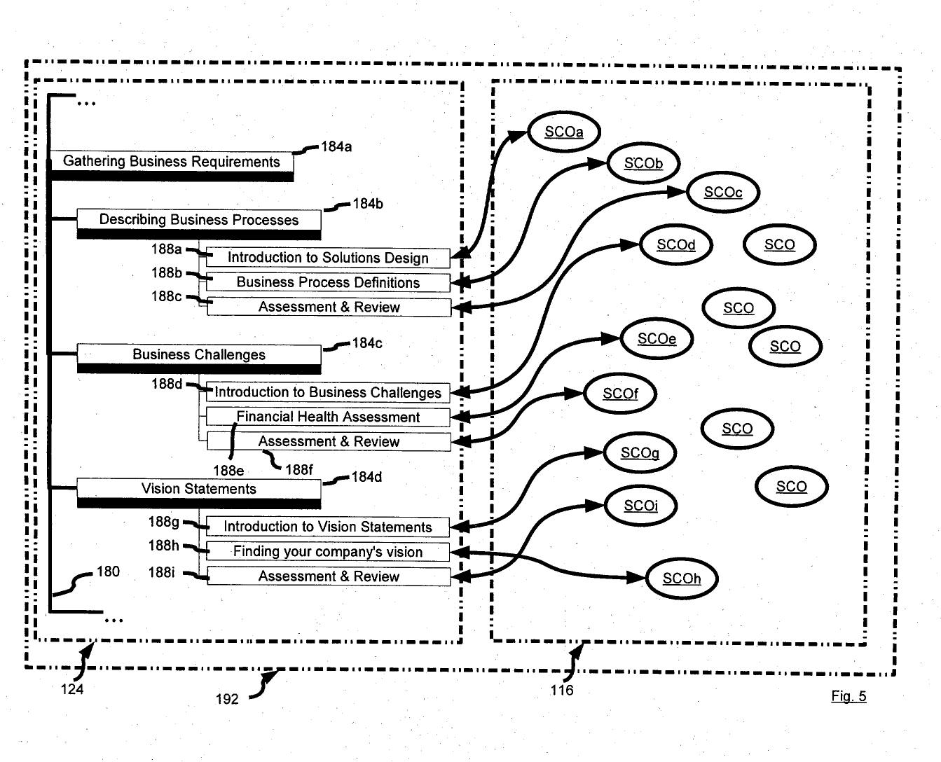

Referring now to FIG. 5, a SCORM v1.2 compliant content aggregation is indicated generally at 192. Content aggregation 192 is based on the examples shown in FIGS. 3 and 4, and thus includes content structure 180 from FIG. 4, as stored on content structure database 124. Content aggregation 192 also includes a pool of learning objects, which in the present embodiment are a pool of sharable content objects SCO that reside in learning objects database 116. Pointer leaves 188a-118i of content structure 180 are thus shown pointing to their respective sharable content objects SCOa-SCOi within database 116. Database 116 is also shown containing a plurality of additional sharable content objects SCOs, that are not shown associated with content structure 180.

It is to be understood, however, that the additional sharable content objects SCO could be associated with a modified version content structure 180, and/or portions of content structure 180 that are represented by ellipses, and/or another content structure that is not included in the present example. Similarly, further sharable content objects SCOs can be added to learning objects database 116, as desired. Finally, it is to be further reiterated that the foregoing discussion, including the discussion of skill requirements database 132, content structure database 124, and learning objects database 116, is merely intended to be an example.

Referring again to FIG. 2, content generation engine 104 and content delivery engine 108 are thus each operable to access and process the contents of databases 116, 124, and 132. In particular, content delivery engine 108 is operable to process content aggregation 192 and thereby deliver training to student S operating content delivery engine 108. Content delivery engine 108 thus operates to deliver the general education training defined in skill requirements database 128.

Content generation engine 104 is operable to allow an administrator A to interact with engine 104 via input devices 104c and output device 104b, and to thereby receive input to create, update, modify, delete or otherwise manage the contents of skill requirements database 132, content structure database 124 and learning objects database 116. Furthermore, CPU tower 104a includes software programming that can automatically generate manifest files and/or course structure and/or other aspects of content structure database 124 based on a variety of input criteria, such as modifications to skill requirements database 132, or receipt of information about a pre-existing skill set of student S that warrants modification of a standard manifest file associated with system 100 to tailor a given skill requirement to that particular student S. Further understanding about the scope of functionality of system 100 and its components will become apparent from the discussion below.

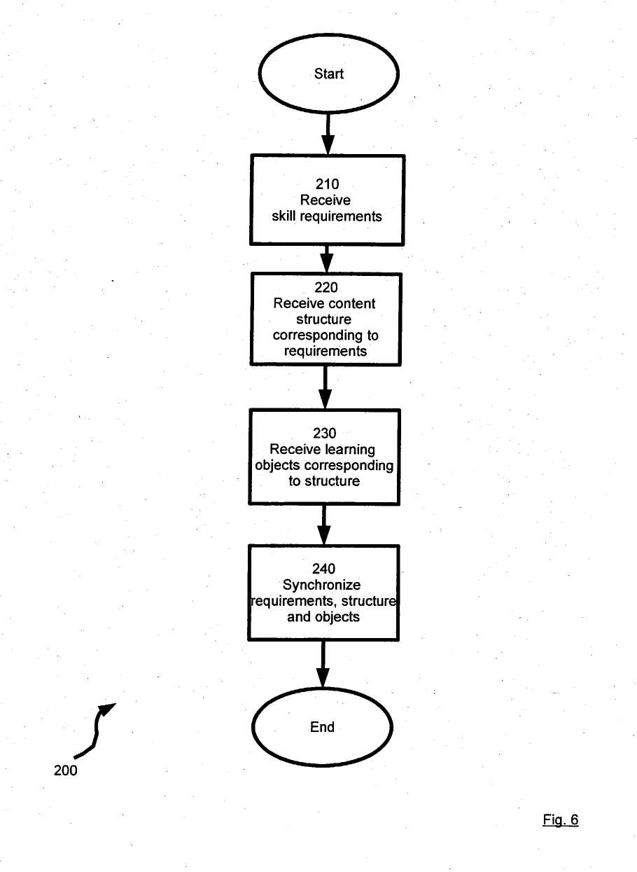

Referring now to FIG. 6, a method for generating educational content is indicated generally at 200. In order to assist in the explanation of method 200, it will be assumed that method 200 is operated using system 100, using the foregoing examples depicted in FIGS. 3-5. It is to be understood that the following discussion of the method of FIG. 6 will lead to further understanding of system 100. (However, it is to be further understood that system 100 and/or method 200 can be varied, and/or that method 200 need not be performed according the exact sequence shown in FIG. 6, and/or that system 100 and method 200 need not work exactly as discussed herein in conjunction with each other, and that such variations are within the scope of the present invention.)

Beginning at step 21 0, a set of skill requirements is received. The set of skill requirements is typically in the form of skill requirements database 132 shown in FIG. 3. When implemented on system 100, this can occur in any number of ways. For example, where no preexisting set of skill requirements exist on storage device 128, then administrator A can simply key-in the set of skill requirements into input device 104a. However, in keeping with the example discussed above, it will be assumed that a preexisting set of skill requirements, (i.e. skill requirements database 132 stored on storage device 128) is loaded onto CPU tower 104a of content generation engine 104. The command to cause the receipt of skill requirements database 132 at engine 104 can be part of an automatic routine executed by engine 104 on a periodic basis, or manually initiated by administrator A.

At step 220, content structure corresponding to the skill requirements are received. When implemented on system 100, this can occur in a number of ways. In keeping with the example discussed above, however, it will be assumed that a preexisting content structure 180, (as stored on storage device 124) is loaded onto CPU tower 104a of content generation engine 104. The command to cause the receipt of content structure 180 at engine 104 can be part of an automatic routine executed by engine 104 on a periodic basis, or manually initiated by administrator A.

Similarly, at step 230, learning objects corresponding to the received content structure are received. Again, this step can occur in a number of ways. Continuing with the above example, when this step is implemented on step 100 it is assumed that the sharable content objects SCOs in learning objects database 116 are loaded onto CPU tower 104a.

At step 240, the received skill requirements, received content structure and received learning objects are synchronized. When implemented on system 100, content generation engine 104 will examine the data received at steps 210-230 and determine whether there are any gaps, redundancies or other discrepancies therebetween, and make corresponding adjustments to one or more of skill requirements database 132, content structure database 124 and/or learning objects database 116 so as to bring them into agreement. The foregoing example demonstrates a simple case—i.e. where the data received at steps 210-230 are already synchronized and accordingly, it would be determined at step 240 that this data is already synchronized and no further action would be necessary. At this point, method 200 would end, and a student S would then have the option to access shareable content objects SCOs according to manifest 180 in the usual manner promulgated by the SCORM v 1.2.

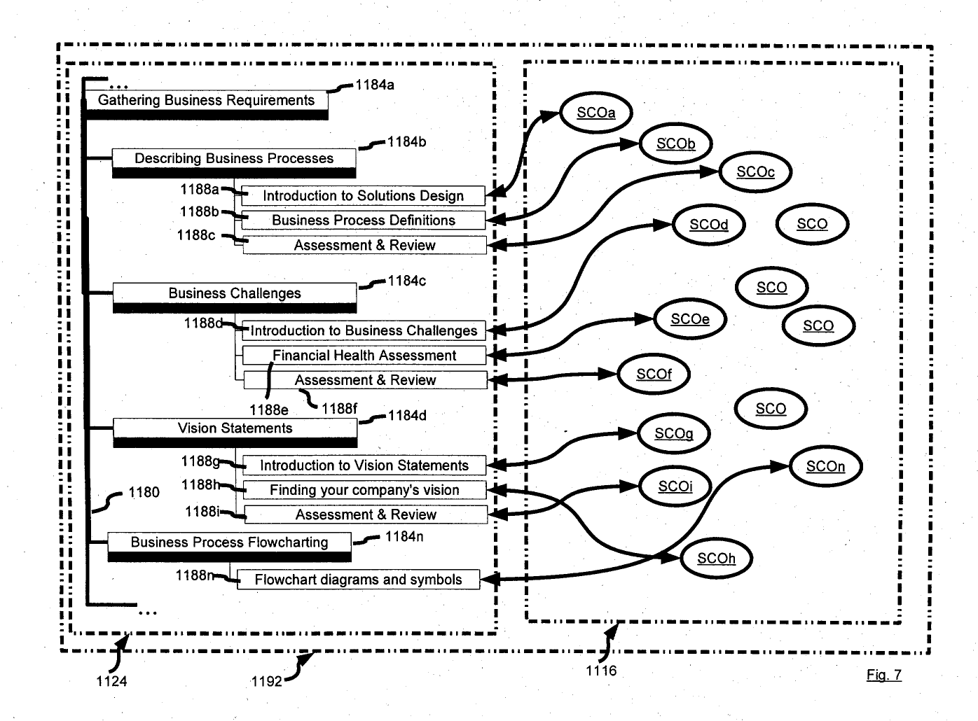

However, it is contemplated that in many circumstances it would be determined at step 240 that the data received at steps 210-230 are not synchronized, and thus further steps would be taken in order to bring them into agreement. As an example, let it be assumed that at step 210 the exemplary skill requirements database 132 of FIG. 3 is received, but that different content structure and learning objects are received at steps 220 and 230, respectively, than the content structure and learning objects shown in FIG. 5. Instead, assume that the content structure and learning objects in FIG. 7 are received at steps 220 and 230.

FIG. 7 shows a SCORM v1.2 compliant (or the like) content aggregation that is indicated generally at 1192, which can be implemented as a SCORM v1.2 compliant manifest file (or the like) for deployment on content delivery engine 108. Aggregation 1192 of FIG. 7 is similar to aggregation 192 of FIG. 5, and like elements in aggregation 1192 to like elements in aggregation 192 are preceded by an additional numeral “1” in their references. Thus aggregation 1192 shows a content structure 1180 having a plurality of sub-roots 1184 and pointer leaves 1188 that point to a plurality of sharable content objects SCOs. The primary difference between content structure 1180 of FIG. 7 and content structure 180 of FIG. 5 is the addition of sub-root 1184n “Business Process Flowcharting”, and its pointer leaf 1188n which points to a sharable content object SCOn within learning objects database 116.

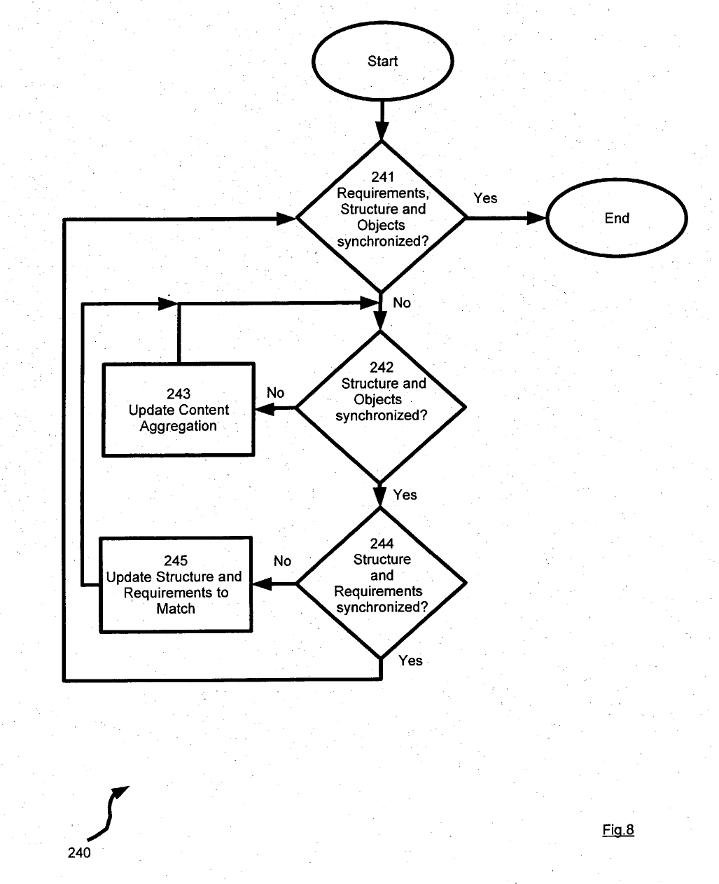

Thus, when method 200 reaches step 240, it will be determined that the data received at steps 210-230 are not synchronized, and that steps will need to be taken in order to synchronize this data. To this end, referring now to FIG. 8, an exemplary method of performing step 240 is indicated generally at 240. At step 241, it is determined whether the data received at steps 210-230 is already synchronized. If the answer is ‘yes’ at step 240 (as in our earlier example where the data received at steps 210-230 matched that data found in FIGS. 4-5), then step 241 advances to “end” and no further action is required.

However, where the data shown in FIG. 3 is received at step 210, and the data shown in FIG. 7 is received at steps 220 and 230, then at step 241 it would be determined that these three pieces of data are not synchronized and the method advances to step 242.

At step 242, it is determined whether content structure received at step 220 is synchronized with the learning objects received at step 230. In the present example, where the data received at steps 220 and 230 are represented by the content aggregation 1192 in FIG. 7, it is determined at step 242 that the content structure 11 80 and learning objects (i.e. sharable content objects SCOs) are synchronized, and so the result at step 242 is “Yes”, and so the method advances to step 244.

At step 244, it is determined whether the content structure received at step 220 is synchronized with the skill requirements received at step 210. In the present example, where the data received at steps 220 is represented by content structure 1180 in FIG. 7, and the skill requirements are represented by skill requirements database 132 (and in particular leaf 168a “Eliciting Business Requirements” thereof) it is determined at step 244 that these two are not synchronized, and then result at step 242 is “No”, and so the method advances to step 245.

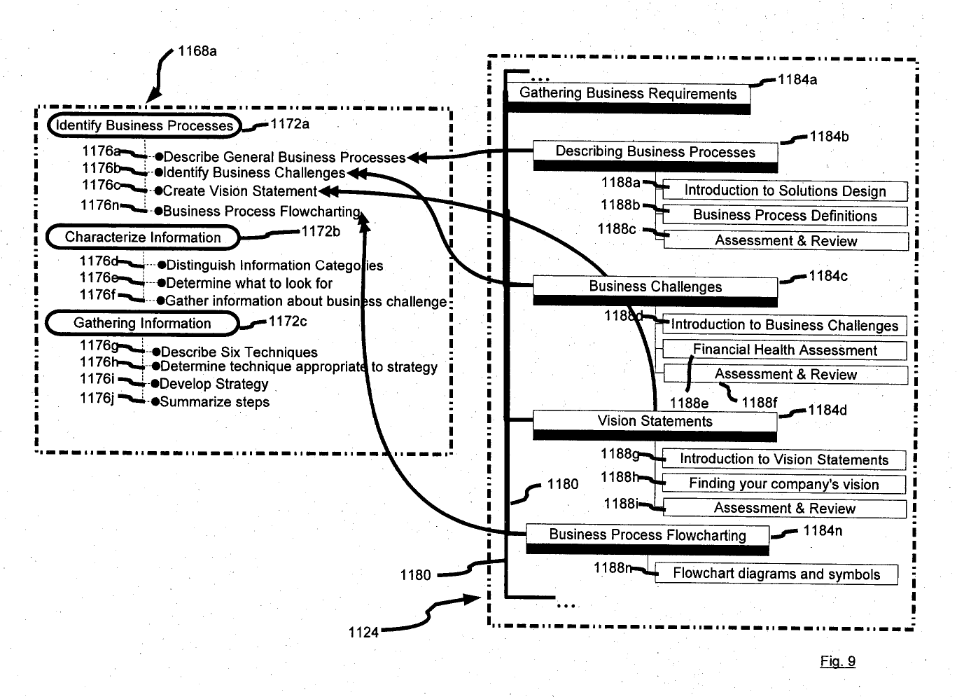

At step 245, the content structure and skill requirements are updated so that they match. Continuing with the present example, the content structure represented by content structure 1180 of FIG. 7 is compared with leaf 168a “Eliciting Business Requirements”, and such comparison reveals the addition of sub-root 1184n “Business Process Flowcharting”. Accordingly, the final result of step 245 is represented in FIG. 9, where skill set 1168a of skill requirements database 132 is shown as updated to add the simple skill 1176n “Business Process Flowcharting” to the list of simple skills 1176 beneath complex skill 1172a “Identify Business Processes”.

At this point, the method returns to step 242, where a check is made again to determine whether content structure received at step 220 is synchronized with the learning objects received at step 230, and in the present example, the result here is “Yes”, so the method advances to step 244, where it is again determined whether the content structure received at step 220 is synchronized with the skill requirements received at step 210, and in during this particular pass through method the result of step 244 is “Yes”, so the method then returns to step 241, where a determination is made that the requirements, structure and objects are all now synchronized, and the method ends.

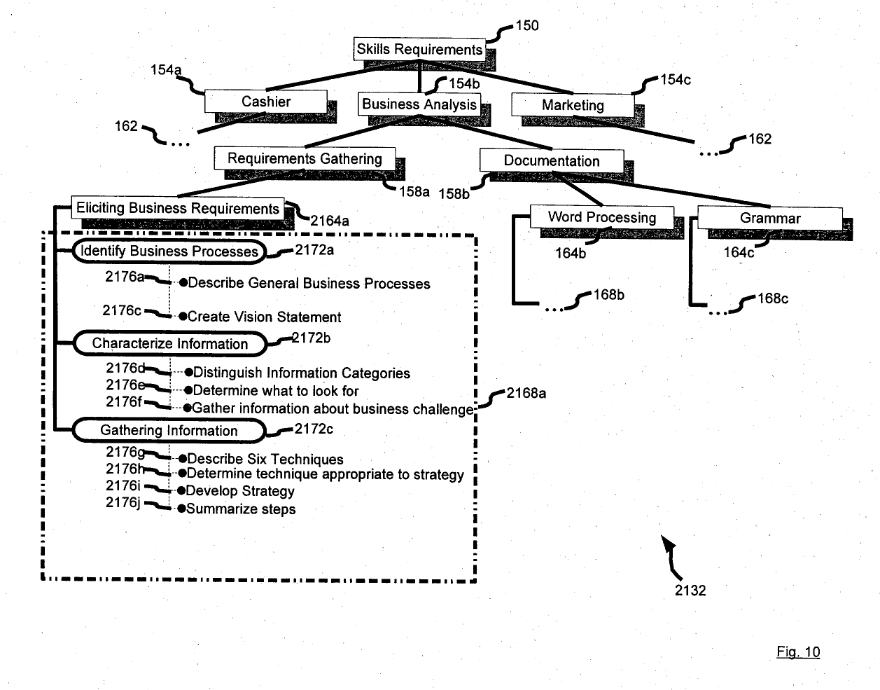

The foregoing is one example of how it can be determined at step 240 that the data received at steps 210-230 are not synchronized, and how steps can be taken in order to bring them into agreement. However, returning again to method 200 in FIG. 6, still further circumstances can occur where it would be determined at step 240 that the data received at steps 210-230 are not synchronized, and thus further steps would be taken in order to bring them into -agreement. As a further example to demonstrate another such circumstance, let it be assumed that the content structure (i.e. content structure 180) in FIG. 5 is received at step 220, and that the learning objects in FIG. 5 (i.e. sharable content objects SCOs) is received at step 230, but that different skill requirements are received at step. 210 than the skill requirements database 132 shown in FIG. 3. Instead, assume that skill requirements database 2132 shown in FIG. 10 is received at step 210.

FIG. 10 shows a skill requirements database that is indicated generally at 2132. Skill requirements data base 2132 of FIG. 10 is similar to skill requirements database 132 of FIG. 3, and like elements in database 2132 to like elements in database are preceded by an additional numeral “2” in their references. Thus skill requirements database 2132 is represented as a tree structure, having a root 150, leaves 154a, 154b and 154c depending from root 150, and further leaves 158 depending from leaf 154b. Leaf 158a “Requirements Gathering” has a leaf 2164a “Eliciting Business Requirements” depending therefrom. Beneath the skill sub-groups represented by leaf 2164a is a skill set 2168a. Skill set 2168a, in turn, comprises a number of complex skills 2172 that group a number simple skills 2176. However, in the example shown in FIG. 10, (in contrast to the example in FIG. 3) complex skill 2172a includes only simple skill 176a “Describe General Business Processes” and simple skill 2176c “Create Vision Statement”. (The simple skill 176b “Identify Business Challenges” from FIG. 3 having been omitted.)

Accordingly, when the content structure 180 in FIG. 5 is received at step 220, and that the learning objects in FIG. 5 (i.e. sharable content objects SCOs) is received at step 230, and skill requirements database 2132 shown in FIG. 10 is received at step 210, when method 200 reaches step 240, action will be taken to synchronize the data received at steps 210-230. Such synchronization can be performed using the steps shown in FIG. 8, wherein at step 241 an initial determination is made whether the data is synchronized, which will return the result “No” and the method will advance to step 242. At step 242, it will be determined whether the content structure received at step 220 is synchronized with the learning objects received at step 230, to which the returned result will be “Yes”.

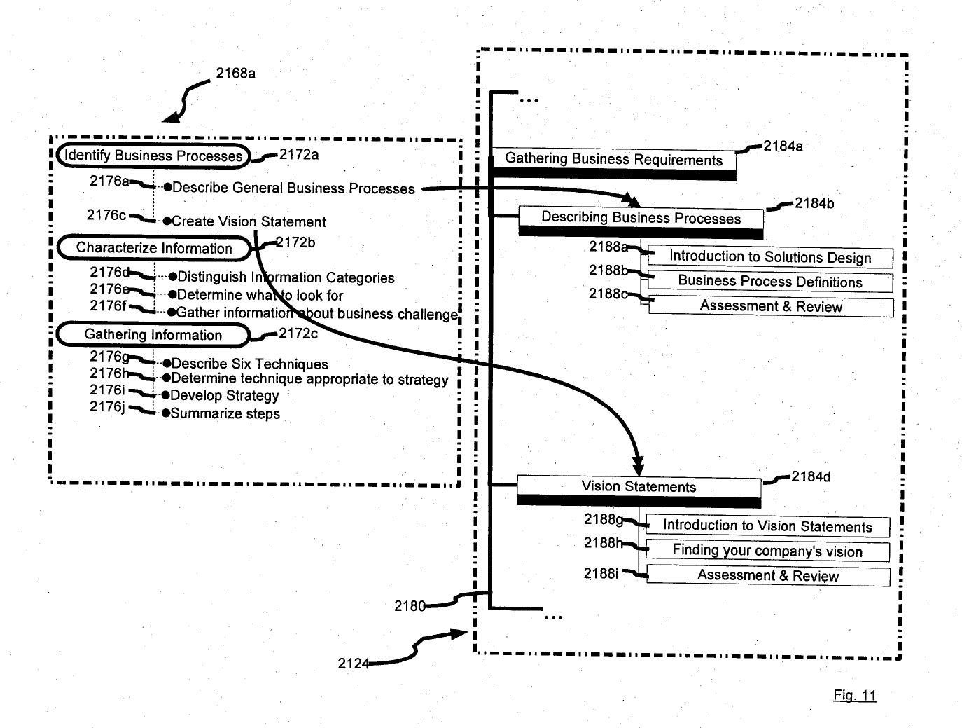

Next, at step 244, it will be determined whether the content structure received at step 230 is synchronized with the skill requirements received at step 210, to which a “No” result will be returned, and so the method advances to step 245 where an update is performed to match the content structure with the skill requirements. In this particular case, it will be determined that skill set 2168a has been updated, and accordingly, an update should be made to the old content structure 180 to synchronize it with the updated skill set 2168a. Accordingly, as represented in FIG. 11, a new content structure 2180 is generated by content generator 104, representing the synchronization that occurred at step 245.

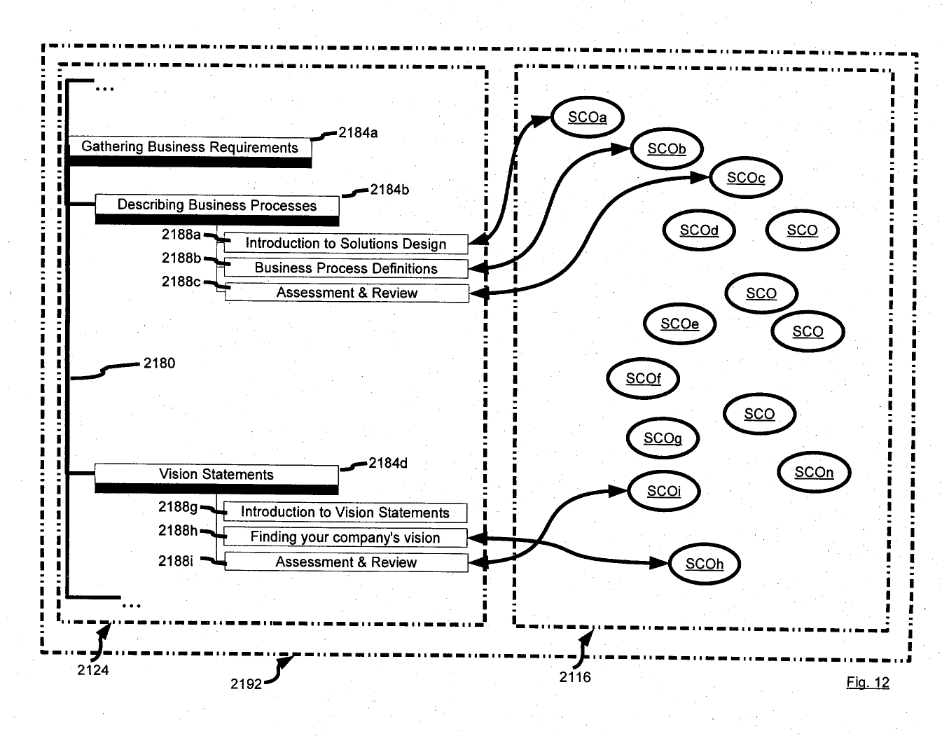

The method then returns to step 242, it will be determined whether the content structure now existing content structure (i.e. updated content structure 2180) is synchronized with the learning objects received at step 230, to which the returned result will now be “No”, and so the method will advance to step 230 where an update is performed to update the content aggregation—i.e. match the content structure with the learning objects. In this particular case, it will be determined that content structure 2180 has been updated, and accordingly, an update should be made to old content aggregation 192 to synchronize it with the updated content structure 2180. Accordingly, as represented in FIG. 12, a new content aggregation 2192 is generated by content generator 104, representing the synchronization that occurred at step 243.

The method then returns back to step 242, where a verification is made that the updated aggregation 2192, including the content structure in content structure 2180, and the contents of learning objects database 2116 are now synchronized, to which a “Yes” result will be returned. The method then advances to step 244, where a verification is made that the content structure in content structure 2180 and the updated skill requirements in skill set 2168a are synchronized, to which a “Yes” result is returned. The method then returns to step 241, where a final verification is made that all of the data is synchronized, to which a “Yes” result is returned, and the method ends.

It will now be apparent to those of skill in the art that any variety of specific situations can occur when method 240 of FIG. 6 is executed, and/or when steps 241-245 of FIG. 8 are executed. In particular, it is contemplated that the means by which skill set 2168a of FIG. 10 is updated can be based on the results of an evaluation of an individual student's preexisting skills, in light of the established requirements outlined in a particular skill set, such as skill set 168a.

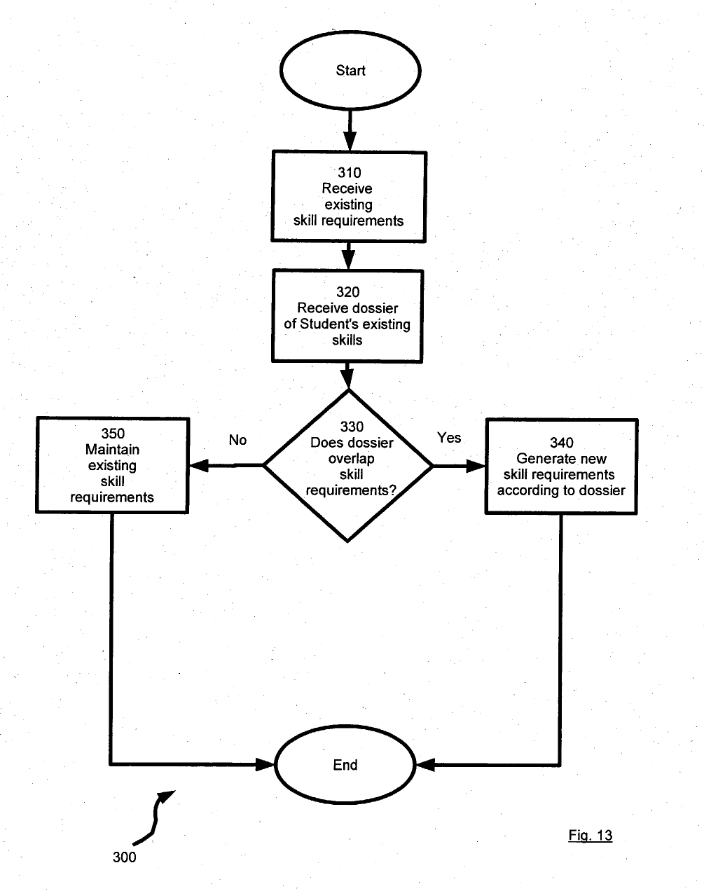

For example, FIG. 13 shows a method 300 for generating a set of skill requirements based on a student's existing skill set. Method 300 can be implemented on any suitable computing device, such as content generator 104 of system 100. At step 310, an existing set of skill requirements is received. For example, skill set 1168 of FIG. 9 is received at CPU tower 104a by loading it from storage device 128.

Next, at step 320, a dossier of Student S's existing skills is received. The means for obtaining this dossier of skills is not particularly limited. For example, student S could be given tests to demonstrate student S's proficiency in each of the skills outlined in skill set 168. Such tests could be administered electronically via content delivery engine 108. Alternatively, administrator A (or other individual) could simply interview student S and reach a subjective determination as to which simple skills 1176 within skill set 1168 that student S is already proficient. The administrator A could then simply key in the results of this evaluation into content generation engine 104. Alternatively, student S could be asked to provide his/her own subjective determination as to student S's proficiency in relation to the skills outlined in skill set 1168. Other means of determining a particular dossier of a student S's existing skills, in light of the contents of skill set 1168 occur to those of skill in the art.

For purposes of the present example, it will be assumed that student S had previously successfully completed a course having a content structure that was based on skill set 168, and thus at step 320 a record of such completion is manually entered into content generation engine 104 by administrator A.

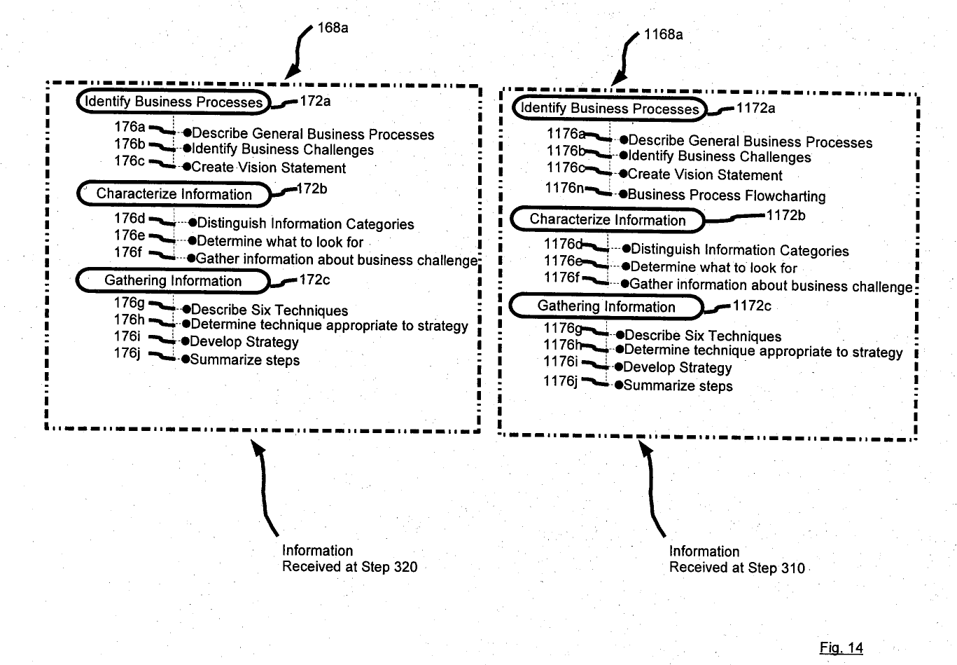

The method then advances to step 330, where a determination is made as to whether the dossier of skills received at step 320 overlaps with the existing skill requirements received at step 310. Continuing with the present example, FIG. 14 shows information received at step 320 beside the information received at step 310, and thus, when a comparison is made therebetween, content generation engine 104 will determine that several of the skills received at step 310 overlap with the skills received at step 320, and thus, the result at step 330 is “Yes”, and the method advances to step 340. (If however, the information received at step 320 had no overlap with the information received at step 310, the method would have advanced to step 350 and the existing skill requirements 1168 would be maintained and thereby comprise the output from method 300).

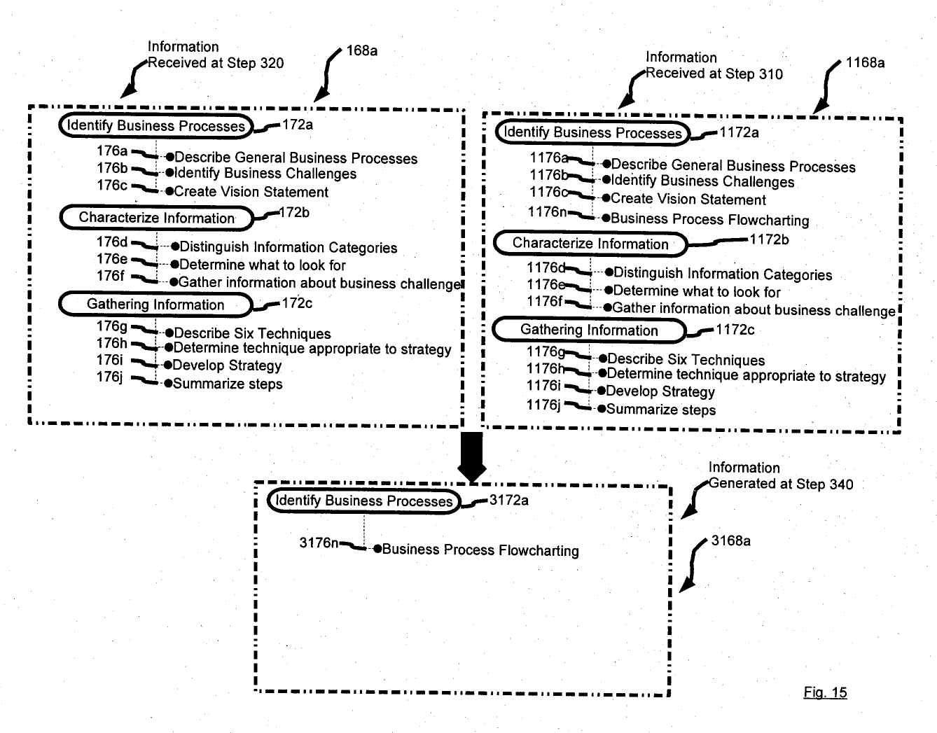

Continuing with the present example, at step 340 a new set of skill requirements is generated according to the dossier, by taking into consideration the overlap between the information received at step 310 and at step 320. FIG. 15 depicts the new skill requirements that are generated based on this example, indicated as skill set 3168a. Having generated skill set 3168a, method 300 ends.

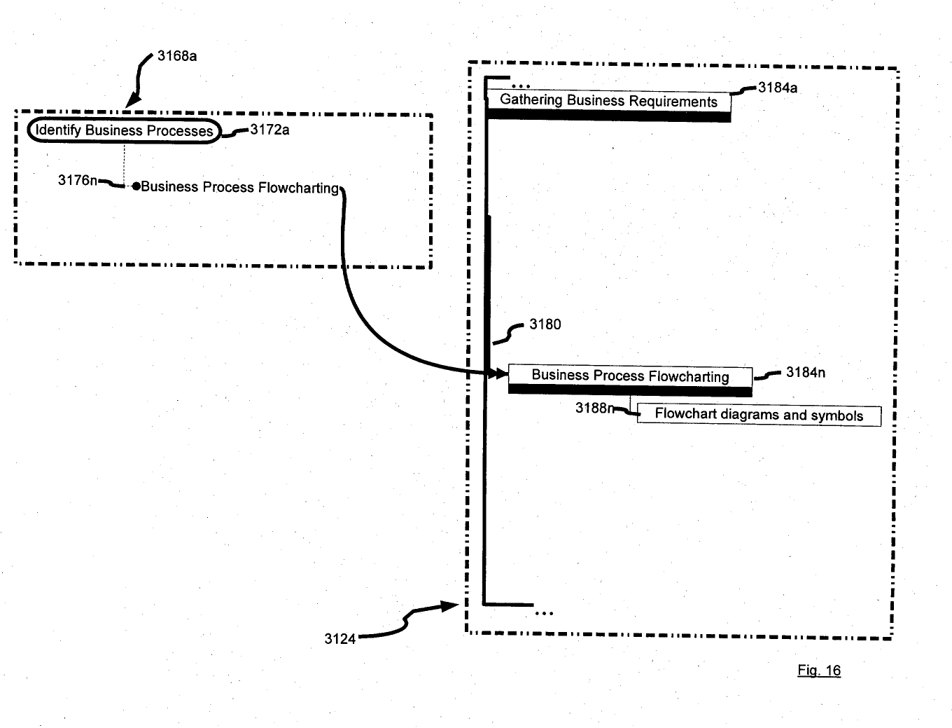

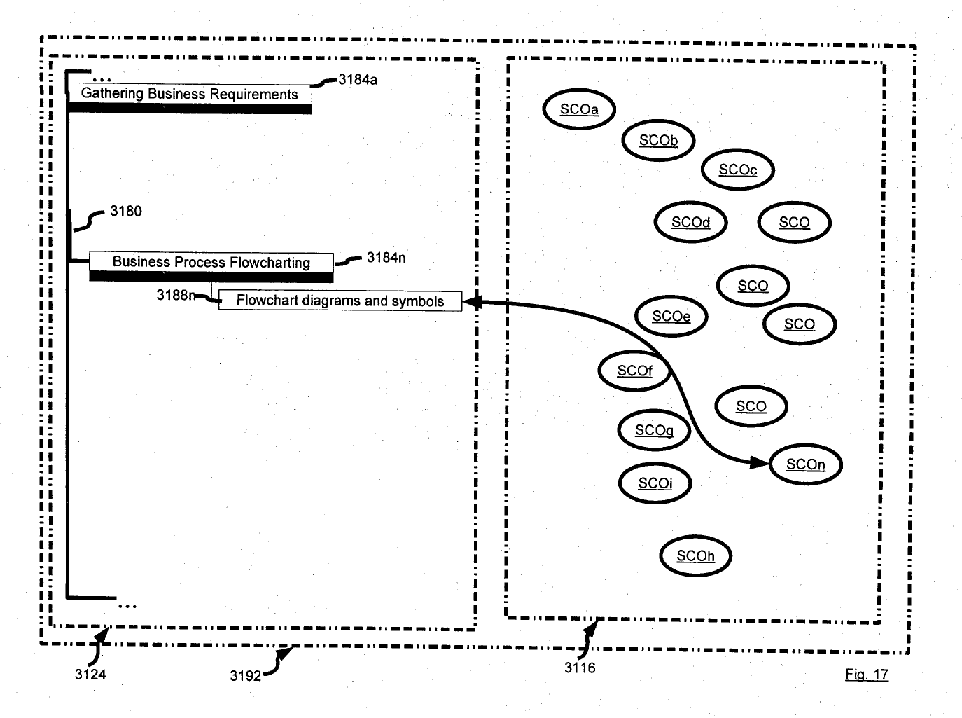

As mentioned previously, method 200 of FIG. 6 can now be rerun using skill set 3168a. Accordingly, at step 210 skill set 3168a would be received. Next at step 220, manifest 180 would be received, and at step 230 sharable content objects SCOs would be received. At step 240, a synchronization would be performed, such as by using the steps 241-245 shown in FIG. 8. After looping through steps 241-245 an appropriate number of times, a manifest 3180 corresponding to skill set 3168 would be generated, and a new content aggregation 3192 would be generated corresponding to skill set 3168a and manifest 3180, as shown in FIGS. 16 and 17, respectively.

While only specific combinations of the various features and components of the present invention have been discussed herein, it will be apparent to those of skill in the art that desired subsets of the disclosed features and components and/or alternative combinations of these features and components can be utilized, as desired. For example, it is to be understood that the particular hardware configurations, operating systems and programming languages used to implement engines 104, 108, storage devices 112, 124 and 132 and system 100 in general are not particularly limited. For example, other types of input devices and output devices can be used. Further, the various components can be interconnected using any known types of interconnections 136 or interconnection means, such as through a wired or wireless connection, a local area or wide area network, direct bus connections, USB or the like. Further, all of the components in system 100 can be implemented in a single computing device, or over a plurality of additional computing devices as desired.

Furthermore, while the foregoing embodiments discuss a substantially static learning objects database 116, it is to be understood that such embodiments are for discussion purposes only, and that the sharable content objects SCO therein can be deleted, updated and/or new sharable content objects SCOs can be added. One example of how new sharable content objects SCOs can be added is be extracting such sharable content object SCOs from a manifest file generated by a third-party, and then depositing the sharable content object SCO into database 116. In this manner, system 100 can be used to efficiently re-use sharable content objects SCOs that are otherwise tied into a respective manifest file generated by third-parties. It is to be further understood that while system 100 refers to a physical database 116, in other embodiments database 116 can be implemented in a distributed manner, across, for example, the entire Internet (or other network), whereby individual sharable content objects SCOs are gathered or accessed from any location on the Internet as needed. Likewise, other databases and components of system 100 can be so implemented.

Furthermore, the tenn “synchronize” is intended to be interpreted broadly—to mean that different synchronizing acts can occur on a user-selectable, or predefined basis. For example, a manually effected change in a particular data set can indicate than an automatic change is to occur on the other two sets of data to bring them into agreement with the first data set. Alternatively, one data set can be identified to always override changes to the other data sets. Alternatively, synchronization can include situations where, for example, no content structure actually previously exists, and the process synchronization includes the generation of an initial content structure based on known set of sharable content objects and a received set of skill requirements. Other types of synchronizations will occur to those of skill in the art.

The above-described embodiments of the invention are intended to be examples of the present invention and alterations and modifications may be effected thereto, by those of skill in the art, without departing from the scope of the invention which is defined solely by the claims appended hereto.

1. A system for generating educational content comprising:
a first database for storing at least one learning object;
a second database for storing at least one content structure that points to said at least one learning object;
a third database for storing at least one set of skill requirements; and,
a content generator engine operable to receive said databases and perform a synchronization operation and output an additional one or more databases including a synchronized version of said first second and third databases.

2. The system according to claim 1 further comprising a content delivery engine for delivering said educational content to a user.

3. The system according to claim 1 wherein said synchronization operation includes comparing said at least one content structure with said at least one skill requirements and updating a desired one of said content structure and said skill requirements based on detected differences therebetween and said outputted additional database comprises said update.

4. The system according to claim 3 wherein said updating is based on examining which of one said content structure and said skill requirements was most recently modified and changing the other one of said content structure and said skill requirements to conform therewith.

5. The system according to claim 1 further including a input device for receiving data to change, update or delete at least one of said databases.

6. The system according to claim 1 wherein said at least one learning object is a SCORM compliant sharable content object.

7. The system according to claim 1 wherein said learning object complies with the learning object standard of the Aviation Industry CBT (Computer-Based Training) Committee (AICC).

8. The system according to claim 1 wherein when said third database and said second database are synchronized and said second database is not synchronized with said first database, then said synchronization operation generates a fourth database based on said second database such that said fourth database is synchronized with said first database, and said synchronization operation generates a fifth database based on said third database such that said fifth database is synchronized with said fourth database.

9. The system according to claim 8 wherein said first database was changed out of synchronization with said second database by extracting one or more learning objects from a SCORM compliant manifest file generated by a third-party and incorporating those extracted learning objects into said first database.

10. The system according to claim 1 wherein one or more of said databases are implemented in a distributed manner across a network.

11. The system according to claim 1 wherein when said first database and said second database are synchronized and said third database is not synchronized with said second database, then said synchronization operation generates a fourth database based on said third database such that said fourth database is synchronized with said second database.

12. The system according to claim 11 wherein said third database was changed out of synchronization with said second database by content delivery engine receiving a dossier of existing student skills reflecting that said existing student's skills overlapped with at least one preexisting said skill requirement in said third third database, and said third database was changed to delete the requirement for said at least one preexisting skills.

13. A method of generating educational content comprising the steps of:
receiving a first set of data representing at least one skill requirement;
receiving a second set of data representing a content structure;
receiving a third set of data representing at least one sharable content object referenced by said content structure;
synchronizing said skill requirements with said content structure; and
outputting data representing said synchronizing step.

14. The method according to claim 13 wherein said synchronization step includes the steps of:
comparing said at least one content structure with said at least one skill requirements; and
updating a desired one of said content structure and said skill requirements based on detected differences therebetween and said outputted additional database comprises said update.

15. The method according to claim 14 wherein said updating step is based on examining which of one said content structure and said skill requirements was most recently modified and changing the other one of said content structure and said skill requirements to conform therewith.

16. The method according to claim 14 wherein said at least one leaning object is a SCORM compliant sharable content object.

17. The method according to claim 16 wherein said learning object complies with the learning object standard of the Aviation Industry CBT (Computer-Based Training) Committee (AICC).

18. The method according to claim 17 wherein when said third database and said second database are synchronized and said second database is not synchronized with said first database, then said synchronization step includes the generation of a fourth database based on said second database such that said fourth database is synchronized with said first database, and said synchronization step further generates a fifth database based on said third database such that said fifth database is synchronized with said fourth database.

19. The method according to claim 18 wherein said first database was changed out of synchronization with said second database by extracting one or more learning objects from a SCORM compliant manifest file generated by a third-party and incorporating those extracted learning objects into said first database.

20. The method according to claim 17 wherein when said first database and said second database are synchronized and said third database is not synchronized with said second database, then said synchronization step includes the generation of a fourth database based on said third database such that said fourth database is synchronized with said second database.

21. The system according to claim 20 wherein said third database was changed out of synchronization with said second database by content delivery engine receiving a dossier of existing student skills reflecting that said existing student's skills overlapped with at least one preexisting said skill requirement in said third database, and said third database was changed to delete the requirement for said at least one preexisting skills.

22. A method of generating a set of skill requirements comprising the steps of:
receiving data representing existing requirements;
receiving data representing a student's existing skills;
determining overlaps between said existing skills and said existing requirements; and,
generating a new set of skill requirements that omits any determined overlaps.
